(19) United States
(12) Patent Application Publication
(10) Pub. No.: US 2013/0311149 A1
(43) Pub. Date: Nov. 21, 2013

(54) Tomographically Enhanced Full Wavefield Inversion

(71) Applicants: Yaxun Tang, Houston, TX (US); Sunwoong Lee, Houston, TX (US); Anatoly Baumstein, Houston, TX (US); David L. Hinkley, Spring, TX (US)

(72) Inventors: Yaxun Tang, Houston, TX (US); Sunwoong Lee, Houston, TX (US); Anatoly Baumstein, Houston, TX (US); David L. Hinkley, Spring, TX (US)

(21) Appl. No.: 13/849,270

(22) Filed: Mar. 22, 2013

Related U.S. Application Data
(60) Provisional application No. 61/648,258, filed on May 17, 2012.

(51) Int. Cl. G06F 17/50

(52) U.S. Cl. CPC G06F 17/50
USPC 703/2

(57) ABSTRACT

Method for improving convergence in gradient-based iterative inversion of seismic data (101), especially advantageous for full wavefield inversion. The method comprises decomposing the gradient into two (or more) components (103), typically the migration component and the tomographic component, then weighting the components to compensate for unequal frequency content in the data (104), then recombining the weighted components (105), and using the recombined gradient to update (106) the physical properties model (102).

### CROSS-REFERENCE TO RELATED APPLICATION

This application claims the benefit of U.S. Provisional Patent Application 61/648,258, filed May 17, 2012 entitled TOMOGRAPHICALLY ENHANCED FULL WAVEFIELD INVERSION, the entirety of which is incorporated by reference herein.

### FIELD OF THE INVENTION

This disclosure relates generally to the field of geophysical prospecting and, more particularly, to seismic data processing. Specifically, the disclosure relates to a method for inverting the full wavefield of seismic data to infer a physical properties model of the subsurface.

### BACKGROUND OF THE INVENTION

Full wavefield inversion (FWI) is a nonlinear inversion technique that recovers the earth model by minimizing the mismatch between the simulated and the observed wavefields. Current implementation of FWI utilizes gradient-based local optimization technique to optimize the model parameters. The gradient-based inversion relies on computing the gradient of the mismatch objective functional. Mora (1989) shows that the FWI gradient comprises contributions from a tomographic term and a migration term. The tomographic term, obtained by cross-correlating the forward-scattered wavefields, mainly updates the long wavelength components of the model parameters, whereas the migration term, obtained by cross-correlating the backward-scattered wavefields, mainly updates the short wavelength components of the model parameters. Conventional FWI does not explicitly distinguish contributions of the tomographic and migration terms, and it implicitly combines these two term with equal weights. This often results in the FWI gradient having very weak tomographic term. This is especially true when the data lack low frequency, and the reflectivity contrast of the media is relatively weak. The lack of tomographic component in the gradient makes the conventional FWI ineffective in updating the background (the long wavelengths) of the model parameters. Therefore, in such situations, the inversion result is often oscillatory, exhibited by cycle skipping between the observed and simulated data. Cycle skipping is known to produce objective functions that have many local minima, which prevent commonly used optimization techniques (e.g., Conjugate Gradient optimization) from finding the true global minimum.

Several approaches have been proposed to tackle the challenge of local minima, with the fundamental idea that the long wavelength component of the model parameters should be updated first. Bunks et al. (1995) uses a multi-scale approach and performs inversion from low frequency to high frequency. Lazaratos et al. (2011) use spectral shaping to boost the low frequency in the data and hence the long wavelength updates in the gradient. Pratt (1999), Sheng et al. (2006), and others, focus on transmitted waves, such as turning waves and refracted waves, to avoid the local minima associated with the reflected arrivals. The multi-scale approach and the spectral shaping approach, however, become ineffective if the observed data lack low frequency, whereas excluding reflected arrivals from FWI severely limits its applicability to imaging deep structures, which is of high interest for exploration seismology.

### SUMMARY OF THE INVENTION

In one embodiment, with reference to the flowchart of FIG. 10, the invention is a computer-implemented method for updating a physical properties model 102 of a subsurface region in iterative inversion of seismic data 101 using a gradient of a cost function that compares the seismic data to model-simulated data. The method comprises, in one or more iteration cycles, (a) decomposing the gradient into at least two components (103), using a computer; (b) weighting the components unequally (104); (c) recombining the weighted components to obtain a modified gradient (105); and (d) using the modified gradient to update the physical properties model (106).

### BRIEF DESCRIPTION OF THE DRAWINGS

The patent or application file contains at least one drawing executed in color. Copies of the patent or patent application publication with color drawings will be provided by the U.S. Patent and Trademark Office upon request and payment of the necessary fee.

However, in countries where the patent rules prohibit the use of color, including the U.S. if the applicant's petition to use color is rejected, the color originals are replaced by black-and-white reproductions.

The present invention and its advantages will be better understood by referring to the following detailed description and the attached drawings in which:

FIG. 1A shows a simple velocity model with a circular anomaly in the center and FIG. 1B shows the initial velocity model used for a test example comparing FWI using traditional methods and using the present inventive method;

FIG. 2 shows the conventional FWI gradient at the first iteration;

FIG. 3 shows the inverted velocity model using the conventional FWI gradient (FIG. 2) after 10 iterations for the model shown in FIGS. 1A-1B;

FIG. 4A shows the extracted tomographic gradient component (forward scatterings); FIG. 4B shows the migration gradient component (backward scatterings) at the first iteration; and FIG. 4C shows the recombined gradient of the present inventive method using a weighting factor λ=3;

FIG. 5 shows inversion results after 10 iterations using the tomographically-enhanced gradient;

FIGS. 6A-6D show four separated gradient components in a second test example that uses the embodiment of the invention that combines gradient components using the angle-domain Hessian;

FIGS. 7A-7J shows the decomposed Hessian components for the second test example; only 10 components are shown because the matrix is symmetric;

FIG. 8 shows the recombined gradient at the first iteration after inverting the angle-domain Hessian using FIGS. 6 and 7, and equation 35;

FIG. 9 shows the inversion result in the second test example after 10 iterations, using the gradient obtained by inverting the angle-domain Hessian;

FIG. 10 is a flowchart showing basic steps in one embodiment of the present inventive method for updating the subsurface model in a gradient-based inversion process;

FIG. 11 is a flowchart showing the embodiment of FIG. 10 and also showing how the decomposed gradient components are obtained by cross-correlating the decomposed forward propagated source wavefield with the decomposed backward propagated data residual;

FIG. 12 is a flow chart showing an embodiment of the present invention using the angle-domain Hessian to re-combine the decomposed gradient components; and

FIG. 13 is a flowchart showing an embodiment of the invention in which an approximate separation of the gradient into tomographic and migration components is effected by applying a band-pass filter directly to the gradient.

The invention will be described in connection with its preferred embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

In the present invention, an alternative approach is presented that explicitly distinguishes the contributions from the tomographic term and the contributions from the migration term to the gradient of the objective (cost) function. The present inventive method enhances one term versus the other, and recombines them to form a new gradient to improve FWI on reflection-dominant data. These two gradient components are extracted by correlating wavefields travelling in specific directions with each other. Directional wavefields may be obtained by performing wavefield decomposition of both source and receiver wavefields.

The theory of FWI will be described in the frequency domain for its simplicity, but the equivalent implementation in the time domain is straightforward. We may first review the conventional FWI gradient, which is obtained by cross-correlating the forward propagated source wavefield with the backward propagated data residual. In the frequency domain, the gradient can be expressed as follows:

$$g ( x ) = {\sum }_{ω} {\sum }_{{x}_{s}} {S}^{*} ( x , {x}_{s} , ω ) R ( x , {x}_{s} , ω ) \qquad ( 1 )$$

where * denotes taking the adjoint, g(x) is the gradient at image point x=(x, y, z), ω is the angular frequency. S(x, xₓ, ω) and R(x, xₛ, ω) are the monochromatic source and receiver wavefields at image point x for a source located at xₛ=(xₛ, yₛ), respectively. The source wavefield is obtained by solving the wave equation forward in time (forward modeling). In the frequency domain, the source wavefield can be expressed as follows

S*(x, xₛ, ω)=A(x, ω)f*ₛ(ω)G*(x, xₛ, ω) (2)

where fₛ(ω) is the source signature; A(x, ω) is a real-valued scaling factor, the form of which is determined by the parameterization that is chosen in FWI; G(x, xₛ, ω) is the Green's function from source xₛ to image point x.

On the other hand, the receiver wavefield is obtained by solving the wave equation backward in time (adjoint modeling). In the frequency domain, the receiver wavefield reads

$$R ( x , {x}_{s} , ω ) = {\sum }_{{x}_{r}} {G}^{*} ( x , {x}_{r} , ω ) r ( {x}_{r} , {x}_{s} , ω ) \qquad ( 3 )$$

where G(x, xᵣ, ω) is the Green's function from the receiver location xᵣ=(xᵣ, yᵣ) to image point x; r(xᵣ, xₛ, ω) is the data residual. If a difference based l₂ objective function is used, one gets

r(xᵣ, xₛ, ω)=W(xᵣ, xₛ)[d(xᵣ, xₛ, ω)−d_{obs}(xᵣ, xₛ, ω)] (4)

where d and d_{obs} are the simulated and observed data, respectively; W denotes the acquisition mask operator, which is 1 where we record data and 0 where we do not.

Both source and receiver wavefields can be decomposed into many local plane waves. Therefore, the source and receiver wavefields can be expressed as superpositions of these local plane waves as follows:

$$\begin{matrix}S ( x , {x}_{s} , ω ) = {\sum }_{{θ}_{s}} S ( x , {x}_{s} , ω ; {θ}_{s} ) & ( 5 ) \\ R ( x , {x}_{s} , ω ) = {\sum }_{{θ}_{r}} R ( x , {x}_{s} , ω ; {θ}_{r} ) & ( 6 )\end{matrix}$$

where θₛ and θᵣ are the local propagation angles for source and receiver wavefields, respectively. They are vectors in 3-D and scalars in 2-D. S(x, xₛ, ω; θₛ) and R(x, xₛ, ω; θᵣ) are the corresponding decomposed source and receiver local plane waves.

Substituting equations 5 and 6 into equation 1 yields

$$\begin{matrix}g ( x ) = {\sum }_{{θ}_{s}} {\sum }_{{θ}_{r}} g ( x , {θ}_{s} , {θ}_{r} ) \\ where & ( 7 ) \\ g ( x , {θ}_{s} , {θ}_{r} ) = {\sum }_{ω} {\sum }_{{x}_{s}} {S}^{*} ( x , {x}_{s} , ω ; {θ}_{s} ) R ( x , {x}_{s} , ω ; {θ}_{r} ) & ( 8 )\end{matrix}$$

Equation 7 shows that the FWI gradient is the sum of the correlations between the source and receiver wavefields propagating in different directions. Mora (1989) shows that different gradient components g(x, θₛ, θᵣ) sample different wavenumbers of the model parameters. In particular, gradient components obtained by correlating source and receiver wavefields traveling in similar directions mainly sample low wavenumbers of the model parameters. On the other hand, gradient components obtained by correlating source and receiver wavefields traveling in opposite directions mainly sample high wavenumbers of the model parameters.

Therefore, we can rewrite the gradient as follows

g(x)=gₜ(x)+gₘ(x) (9)

where gₜ(x) and gₘ(x) denote the tomographic and migration component of the gradient, respectively, and they can be defined as follows:

$$\begin{matrix}{g}_{t} ( x ) = {\sum }_{{θ}_{s}} {\sum }_{{θ}_{r}} g ( x , {θ}_{s} , {θ}_{r} ) , & if n ( {θ}_{s} ) \cdot n ( {θ}_{r} ) > cos γ & ( 10 ) \\ {g}_{m} ( x ) = {\sum }_{{θ}_{s}} {\sum }_{{θ}_{r}} g ( x , {θ}_{s} , {θ}_{r} ) , & if n ( {θ}_{s} ) \cdot n ( {θ}_{r} ) \leq cos γ & ( 11 )\end{matrix}$$

where n(·) denotes the unit directional vector, and 0°≦γ≦90° is a user supplied threshold to separate these two different components.

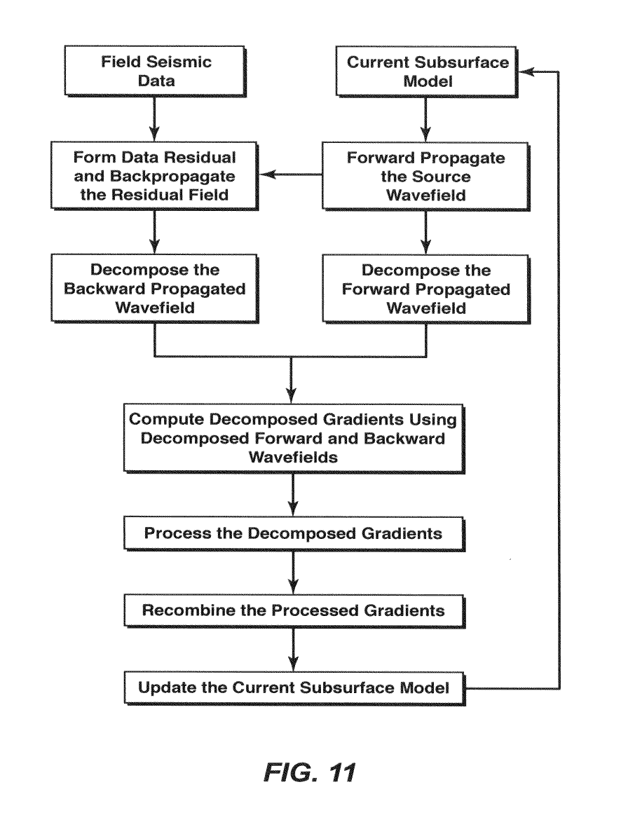

The embodiment of the invention just described is summarized in the flowchart of FIG. 11.

The simplest case for wavefield decomposition is to decompose wavefields into only up- and down-going directions. Then the tomographic and migration components of the gradient can be easily obtained as follows

$$\begin{matrix}{g}_{t} ( x ) = {\sum }_{ω} {\sum }_{{x}_{s}} [ {S}_{D}^{*} ( x , {x}_{s} , ω ) {R}_{D} ( x , {x}_{s} , ω ) + {S}_{U}^{*} ( x , {x}_{s} , ω ) {R}_{U} ( x , {x}_{s} , ω ) ] & ( 12 ) \\ {g}_{m} ( x ) = {\sum }_{ω} {\sum }_{{x}_{s}} [ {S}_{D}^{*} ( x , {x}_{s} , ω ) {R}_{U} ( x , {x}_{s} , ω ) + {S}_{U}^{*} ( x , {x}_{s} , ω ) {R}_{D} ( x , {x}_{s} , ω ) ] & ( 13 )\end{matrix}$$

where the subscripts U and D denote the corresponding up- and down-going wavefields.

Note that the conventional FWI gradient (equation 9) does not distinguish these different components of the gradient, which is equivalent to adding the tomographic and migration components together with equal weights. For reflection dominant data, where the turning waves or refractions are unavailable, the tomographic component in the FWI gradient is often weak due to the weak amplitudes of the reflected transmission in both source and receiver wavefields. Therefore, the gradient lacks low spatial wavenumber components, which tend to control the smooth, or background, part of the model, and so conventional FWI mainly updates the short wavelengths of the model parameters, which tend to control the rough or contrast parts of the model. This phenomenon makes it difficult for the conventional FWI to match the kinematics of the observed data (the kinematics of wavefield are mainly determined by the long wavelengths of the model parameters). As a consequence, conventional FWI easily converges to local minima, and it requires a very good initial model to converge to a reasonable solution.

Accordingly, in one embodiment, the present inventive method decomposes the FWI gradient into the tomographic and migration components, and then applies different processing to these two components. One can, for example, apply a higher weighting factor on the tomographic component than the migration component for reflection-dominant data. These processed gradients are then recombined to form a new gradient to improve the long wavelength updates of the gradient. For reflection-dominant data, where turning waves or refractions are unavailable, it is the reflected wave that transmits through the velocity anomalies that provides the long wavelength information of the model parameters. The generation of reflected transmission requires the existence of reflectors. Therefore, it is necessary to include the migration component in the new gradient even for updating the long wavelengths of model parameters. If the data are transmission dominant (i.e., turning waves and refractions), however, using only tomographic components for FWI gradient might be sufficient for updating the long wavelengths of the model parameters. On the other hand, if one determines that the background model (or the model at the current iteration) is sufficiently accurate, and wishes only to update the contrast of the model parameters, one may decide to use only the migration component of the gradient, which only updates the short wavelengths of the model parameters.

In the following sections, examples are given of three possible ways to determine the weighting factor(s) in forming the new gradient.

### Single-Direction Update

The gradient is reconstructed using both components with a weighting function that favors the tomographic component of the gradient. If a steepest-descent method is used, the corresponding search direction then becomes

s=−(λgₜ+gₘ) (14)

where λ is a scalar that determines the strength of the tomographic component. If λ is 1, then the method becomes the conventional FWI. The scaling factor λ can be a function of FWI iterations. At early iterations, λ may take a relatively big value (>1) to enhance the tomographic component of the gradient, which updates the long wavelengths of the model parameters. As iteration goes on, we can gradually decrease λ to increase the role of short wavelength update of the model parameters.

The factor λ can be set to smaller than 1 in situations where the initial (or current) model is accurate enough so that updating only the contrast is necessary. To briefly review, the criteria for enhancing the migration component (λ<1) are typically determined by the correctness of the initial model (or the model at the current iteration), not by the frequency content of the data.

Once the search direction is determined, any line-search algorithm can be used to find the optimal step length for model updating. We may calculate the step length based on a quadratic approximation of the objective function (Mora 1987). For a given search direction s, the FWI objective function can be approximated using the following quadratic form:

J(mₙ+αs)≈J(mₙ)+αs*g(mₙ)+1/2α²s*H_{g}(mₙ)s (15)

where mₙ is the model vector at the n th iteration, α is the step length and H_{g}(mₙ) is the Gauss-Newton Hessian matrix. The above quadratic function reaches its minimum when its derivative with respect to α is zero, and we obtain

$$α = - \frac{{s}^{*} g ( {m}_{n} )}{{s}^{*} {H}_{g} ( {m}_{n} ) s} \qquad ( 16 )$$

### Dual-Direction Update

The gradient can also be recombined adaptively at each iteration using a dual-direction update scheme discussed below. The two decomposed components define two different search directions. If a steepest-descent method is used, we have

sₜ=−gₜ (17)

sₘ=−gₘ (18)

where sₜ and sₘ are the search directions according to the tomographic component gₜ and migration component gₘ, respectively. We can also expand the objective function using the quadratic approximation

J(mₙ+αsₜ+βsₘ)≈J(mₙ)+(αsₜ+βsₘ)*g(mₙ)+1/2(αsₜ+βsₘ)*H_{g}(mₙ)(αsₜ+βsₘ) (19)

The minimum of the above function is achieved by setting its derivatives with respect to both α and β to zeros. This results in the following two-by-two system:

$$( \begin{matrix}{s}_{t}^{*} {H}_{g} ( {m}_{n} ) {s}_{t} & \frac{1}{2} [ {s}_{t}^{*} {H}_{g} ( {m}_{n} ) {s}_{m} + {s}_{m}^{*} {H}_{g} ( {m}_{n} ) {s}_{t} ] \\ \frac{1}{2} [ {s}_{m}^{*} {H}_{g} ( {m}_{n} ) {s}_{t} + {s}_{t}^{*} {H}_{g} ( {m}_{n} ) {s}_{m} ] & {s}_{m}^{*} {H}_{g} ( {m}_{n} ) {s}_{m}\end{matrix} ) ( \begin{matrix}α \\ β\end{matrix} ) = ( \begin{matrix}- {s}_{t}^{*} g ( {m}_{n} ) \\ - {s}_{m}^{*} g ( {m}_{n} )\end{matrix} ) \qquad ( 20 )$$

The model parameters are then updated using

mₙ₊₁=mₙ+αsₜ+βsₘ (21)

Note that the dual-direction scheme requires one more evaluation of Hessian-vector multiplication compared to the single-direction update scheme. See 61/564,669 by Lee and Baumstein for an efficient way to estimate the Hessian times vector.

### Combining Gradient Components Using the Angle-Domain Hessian

With equations 2, 3, 5, 6 and 7, we rewrite equation 8 in terms of Green's functions as follows:

$$g ( x , {θ}_{s} , {θ}_{r} ) = {\sum }_{ω} {\sum }_{{x}_{s}} {\sum }_{{x}_{r}} A ( x , ω ) {f}_{s}^{*} ( ω ) {G}^{*} ( x , {x}_{s} , ω ; {θ}_{s} ) {G}^{*} ( x , {x}_{r} , ω ; {θ}_{r} ) r ( {x}_{r} , {x}_{s} , ω ) \qquad ( 22 )$$

Equation 22 establishes a linear relationship between the angle-dependent gradient and the data residual. From equation 22, we can obtain the corresponding linear forward equation as follows:

$$r ( {x}_{r} , {x}_{s} , ω ) = {\sum }_{x} {\sum }_{{θ}_{s}} {\sum }_{{θ}_{r}} A ( x , ω ) {f}_{s} ( ω ) G ( x , {x}_{s} , ω ; {θ}_{s} ) G ( x , {x}_{r} , ω ; {θ}_{r} ) \tilde{g} ( x , {θ}_{s} , {θ}_{r} ) \qquad ( 23 )$$

Note that \tilde{g}(x, θₛ, θᵣ) is different from g(x, θₛ, θᵣ), because the forward operator in equation 23 is not orthogonal, hence its adjoint (equation 22) is not its inverse.

The normal equation of equation 23 is

$${\sum }_{{x}^{′}} {\sum }_{{θ}_{s}^{′}} {\sum }_{{θ}_{r}^{′}} H ( x , {θ}_{s} , {θ}_{r} ; {x}^{′} , {θ}_{s}^{′} , {θ}_{r}^{′} ) \tilde{g} ( {x}^{′} , {θ}_{s}^{′} , {θ}_{r}^{′} ) = g ( x , {θ}_{s} , {θ}_{r} ) \qquad ( 24 )$$

where H(x, θₛ, θᵣ; x′, θ′ₓ, θ′ᵣ) is the angle-dependent Gauss-Newton Hessian operator defined as follows:

$$H ( x , {θ}_{s} , {θ}_{r} ; {x}^{′} , {θ}_{s}^{′} , {θ}_{r}^{′} ) = {\sum }_{ω} {\sum }_{{x}_{s}} {\sum }_{{x}_{r}} {\vert {f}_{s} ( ω ) \vert}^{2} A ( x , ω ) {G}^{*} ( x , {x}_{s} , ω ; {θ}_{s} ) {G}^{*} ( x , {x}_{r} , ω ; {θ}_{r} ) A ( {x}^{′} , ω ) G ( {x}^{′} , {x}_{s} , ω ; {θ}_{s}^{′} ) G ( {x}^{′} , {x}_{r} , ω ; {θ}_{r}^{′} ) \qquad ( 25 )$$

The solution of equation 24 gives the negative of the Gauss-Newton direction for the FWI problem. In 3-D, the Hessian is of 14 dimensions and is impractical to calculate. If we ignore the blurring effect of the Hessian kernel on the spatial axes, we reduce the Hessian to a 11 dimension object, and we obtain:

$$\begin{matrix} {\sum }_{{θ}_{s}^{′}} {\sum }_{{θ}_{r}^{′}} H ( x , {θ}_{s} , {θ}_{r} ; {θ}_{s}^{′} , {θ}_{r}^{′} ) \tilde{g} ( x , {θ}_{s}^{′} , {θ}_{r}^{′} ) \approx g ( x , {θ}_{s} , {θ}_{r} ) \\ where & ( 26 ) \\ H ( x , {θ}_{s} , {θ}_{r} ; {θ}_{s}^{′} , {θ}_{r}^{′} ) = {\sum }_{ω} {\sum }_{{x}_{s}} {\sum }_{{x}_{r}} {A}^{2} ( x , ω ) {\vert {f}_{s} ( ω ) \vert}^{2} {G}^{*} ( x , {x}_{s} , ω ; {θ}_{s} ) {G}^{*} ( x , {x}_{r} , ω ; {θ}_{r} ) G ( x , {x}_{s} , ω ; {θ}_{s}^{′} ) G ( x , {x}_{r} , ω ; {θ}_{r}^{′} ) & ( 27 )\end{matrix}$$

Let us consider the simplest case where we decompose both source and receiver Green's functions into only up- and down-going directions as follows. But one should note that this method can be generalized to include additional angular directions beyond up- and down-going directions, as described by equations 22-27.

G(x, xₛ, ω)=G_{D}(x, xₛ, ω)+G_{U}(x, xₛ, ω) (28)

G(x, xᵣ, ω)=G_{D}(x, xᵣ, ω)+G_{U}(x, xᵣ, ω) (29)

Substituting equations 28 and 29 into 22 yields 4 different gradient components as follows:

$$\begin{matrix}{g}_{DD} ( x ) = {\sum }_{ω} {\sum }_{{x}_{s}} {\sum }_{{x}_{r}} A ( x , ω ) {f}_{s}^{*} ( ω ) {G}_{D}^{*} ( x , {x}_{s} , ω ; {θ}_{s} ) {G}_{D}^{*} ( x , {x}_{r} , ω ; {θ}_{r} ) r ( {x}_{r} , {x}_{s} , ω ) & ( 30 ) \\ {g}_{DU} ( x ) = {\sum }_{ω} {\sum }_{{x}_{s}} {\sum }_{{x}_{r}} A ( x , ω ) {f}_{s}^{*} ( ω ) {G}_{D}^{*} ( x , {x}_{s} , ω ; {θ}_{s} ) {G}_{U}^{*} ( x , {x}_{r} , ω ; {θ}_{r} ) r ( {x}_{r} , {x}_{s} , ω ) & ( 31 ) \\ {g}_{UD} ( x ) = {\sum }_{ω} {\sum }_{{x}_{s}} {\sum }_{{x}_{r}} A ( x , ω ) {f}_{s}^{*} ( ω ) {G}_{U}^{*} ( x , {x}_{s} , ω ; {θ}_{s} ) {G}_{D}^{*} ( x , {x}_{r} , ω ; {θ}_{r} ) r ( {x}_{r} , {x}_{s} , ω ) & ( 32 ) \\ {g}_{UU} ( x ) = {\sum }_{ω} {\sum }_{{x}_{s}} {\sum }_{{x}_{r}} A ( x , ω ) {f}_{s}^{*} ( ω ) {G}_{U}^{*} ( x , {x}_{s} , ω ; {θ}_{s} ) {G}_{U}^{*} ( x , {x}_{r} , ω ; {θ}_{r} ) r ( {x}_{r} , {x}_{s} , ω ) & ( 33 )\end{matrix}$$

Similarly, substituting equations 28 and 29 into 25 yields 16 different Hessian components. For simplicity, we write each component of the Hessian in the following general form

$${H}_{KL}^{IJ} ( x ) = {\sum }_{ω} {\sum }_{{x}_{s}} {\sum }_{{x}_{r}} {A}^{2} ( x , ω ) {\vert {f}_{s} ( ω ) \vert}^{2} {G}_{I}^{*} ( x , {x}_{s} , ω ) {G}_{J}^{*} ( x , {x}_{r} , ω ) {G}_{K} ( x , {x}_{s} , ω ) {G}_{L} ( x , {x}_{r} , ω ) \qquad ( 34 )$$

where I, J, K, L take values of D and U, respectively.

Equations 26 and 30-34 together result in a 4 by 4 system at each image point as follows:

$$( \begin{matrix}{H}_{DD}^{DD} ( x ) & {H}_{DU}^{DD} ( x ) & {H}_{UD}^{DD} ( x ) & {H}_{UU}^{DD} ( x ) \\ {H}_{DD}^{DU} ( x ) & {H}_{DU}^{DU} ( x ) & {H}_{UD}^{DU} ( x ) & {H}_{UU}^{DU} ( x ) \\ {H}_{DD}^{UD} ( x ) & {H}_{DU}^{UD} ( x ) & {H}_{UD}^{UD} ( x ) & {H}_{UU}^{UD} ( x ) \\ {H}_{DD}^{UU} ( x ) & {H}_{DU}^{UU} ( x ) & {H}_{UD}^{UU} ( x ) & {H}_{UU}^{UU} ( x )\end{matrix} ) ( \begin{matrix}{\tilde{g}}_{DD} ( x ) \\ {\tilde{g}}_{DU} ( x ) \\ {\tilde{g}}_{UD} ( x ) \\ {\tilde{g}}_{UU} ( x )\end{matrix} ) = ( \begin{matrix}{g}_{DD} ( x ) \\ {g}_{DU} ( x ) \\ {g}_{UD} ( x ) \\ {g}_{UU} ( x )\end{matrix} ) \qquad ( 35 )$$

Because the matrix defined in equation 35 is symmetric, only 10 different Hessian components are actually required. We calculate the 10 different components using the phase encoding, as described in Tang, 2008; Tang, 2009; Tang and Lee, 2010.

Once equation 35 is solved, we obtain \tilde{g}_{DD}(x), \tilde{g}_{DU}(x), \tilde{g}_{UD}(x), \tilde{g}_{UU}(x) at each image point x. We recombine these 4 components to determine the corresponding search direction:

s(x)=−[\tilde{g}_{DD}(x)+\tilde{g}_{DU}(x)+\tilde{g}_{UD}(x)+\tilde{g}_{UU}(x)] (36)

and the model parameters are updated using

mₙ₊₁=mₙ+ηs (37)

where η is a scalar which can be determined by line search. Generally speaking, a line search is not necessary, because the inverse of Hessian should automatically give the correct scaling factor for mode updates. Therefore, in most cases, setting η=1 is sufficient.

Note that equations 35 and 36 effectively provide spatially-varying weights onto the separated gradient components. Therefore, it is different from the fixed weighting schemes discussed in previous single- and dual-direction updating schemes, where the weights are spatially invariant.

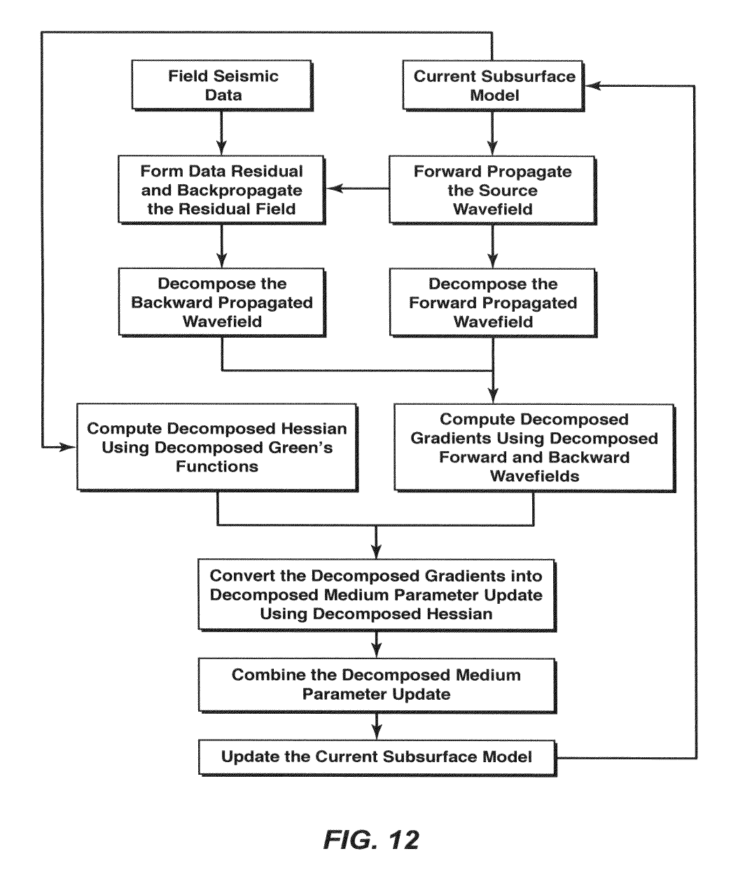

The above-described Hessian embodiment of the invention is summarized in the flowchart of FIG. 12.

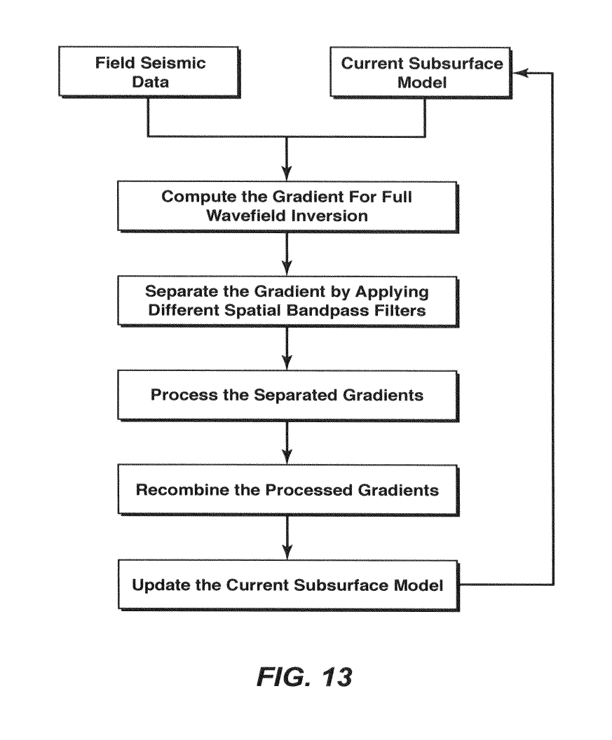

While the previous derivation is given using the decomposition of the wavefields into only up- and down-going directions, it should be noted that the method can be generally applied to the cases where the wavefields are decomposed into many different directions. This results in the gradient to be separated into many different components. These wavefield decompositions can, for example, be a function of wave propagation angle. The directional decomposition of the wavefield can be performed by frequency-wavenumber separation (Hu and McMechan, 1987; Liu, 2012), as described in the background section; by time-wavenumber separation (Liu et al., 2007, 2011); by local slant stack (Xie and Wu, 2002, or Xie et al. 2006); or it can be achieved by applying Poynting vector to the wavefield, as described in Yoon et al. (2004), or by Dickens and Winbow (2011). Additionally, it is possible to perform an approximate separation of the gradient into the tomographic and migration components through (for example) wave-number filtering directly, without first splitting the wavefield into different components. In the latter case, one could apply a band-pass filter directly to the gradient to separate the predominantly low-wavenumber part (tomographic kernel) from the high-wavenumber part (migration kernel). This embodiment of the present invention is summarized in the flowchart of FIG. 13.

### Test Example

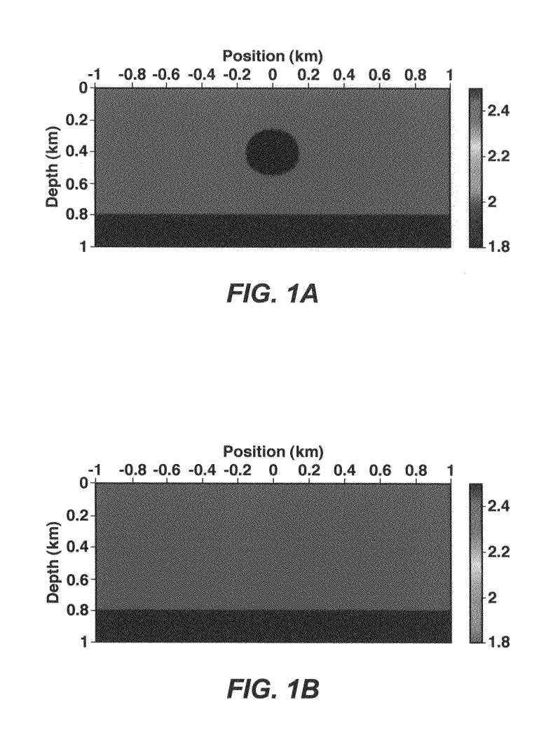

The present inventive method was tested on a simple model shown in FIG. 1A. The velocities for the first and second layers are 2 km/s and 2.5 km/s, respectively. The velocity of the circular anomaly is 1.8 km/s. 51 shots were generated, ranging from −1.5 km to 1.5 km with a sampling of 0.6 km. The receiver spread is fixed for all shots, and it ranges from −1.5 km to 1.5 km with a sampling of 0.01 km. The source function is a Ricker wavelet with a fundamental frequency of 10 Hz. FIG. 1B shows the corresponding initial velocity model used for FWI in this example exercise.

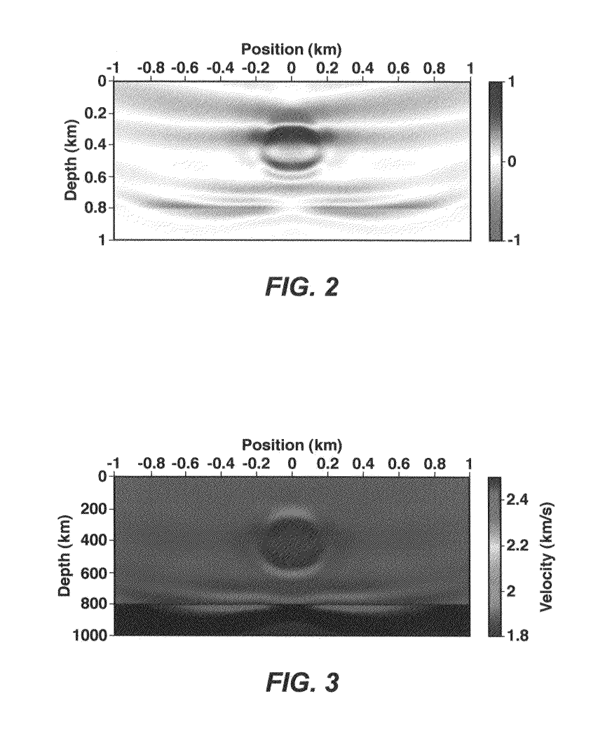

FIG. 2 shows the conventional FWI gradient of the difference-based l₂ norm objective function at the first iteration using the initial model shown in FIG. 1B. Note that the high wavenumber updates dominate in the gradient, and the low wavenumber updates are very weak. In other words, the gradient in FIG. 2 shows strong amplitudes in the velocity contrast region (the boundary of the circular anomaly and the interface below it), but lacks smooth background update inside the circular anomaly region. This phenomenon is explained by the fact that the weak velocity contrast between the two layers in model shown in FIGS. 1A-1B results in weak reflected arrivals transmitting through the anomaly, and hence the weak tomographic component in the FWI gradient.

The inverted velocity model obtained using the conventional FWI gradient after 10 iterations of the full wavefield inversion is shown in FIG. 3. As expected, the inversion recovers only the boundaries of the circular anomaly and the inner part is almost not recovered at all.

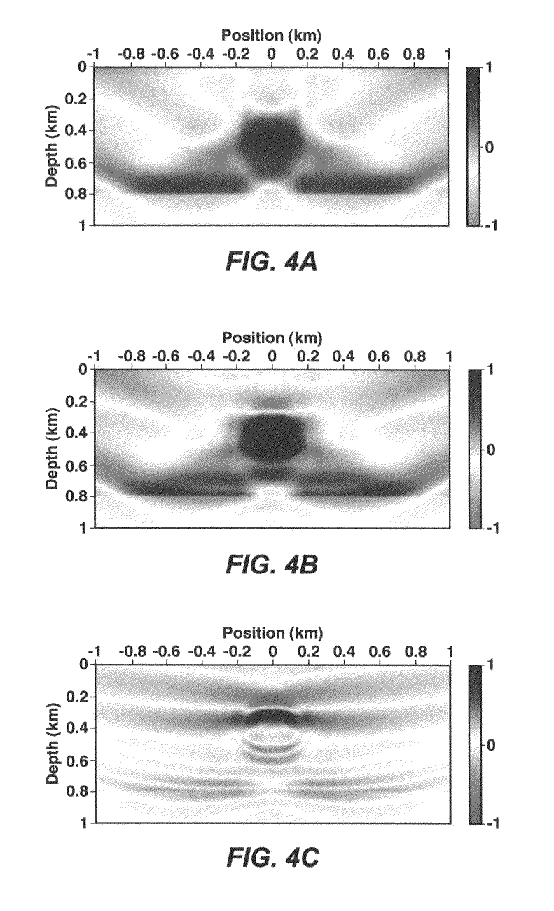

Next, both source and receiver wavefields are decomposed into up- and down-going wavefields to generate different components of the gradient. FIGS. 4A and 4B present the tomographic (forward scatterings) and migration (backward scatterings) components of the gradient, respectively. The tomographic component in FIG. 4A, obtained by correlating wavefields traveling in similar directions, provides long wavelength updates to the model parameters, and so shows large spatial background update information. The migration component in FIG. 4B, obtained by correlating wavefields traveling in opposite directions, provides short wavelength updates to the model parameters, and so shows strong amplitude at the velocity contrast boundaries. FIG. 4C shows the recombined gradient with λ=3. Comparing with FIG. 2, the tomographically enhanced gradient considerably boosts the long wavelength updates that are missing in the conventional gradient, and exhibits both smooth background update information and velocity boundary information.

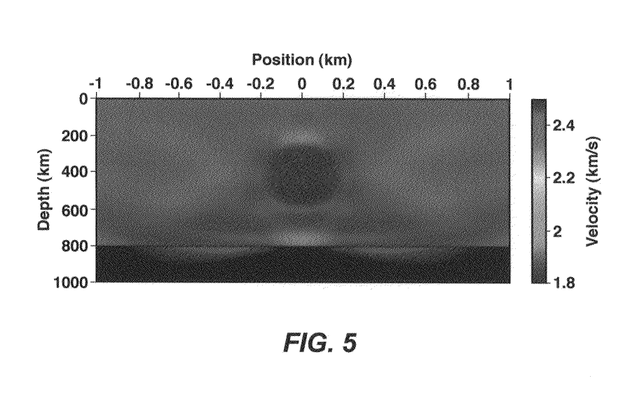

FIG. 5 shows the inverted model after 10 iterations using the tomographically enhanced gradient, where the weighting factor λ=3 is fixed for all iterations. The tomographically enhanced FWI recovers not only the boundaries but also the inner parts of the circular velocity anomaly.

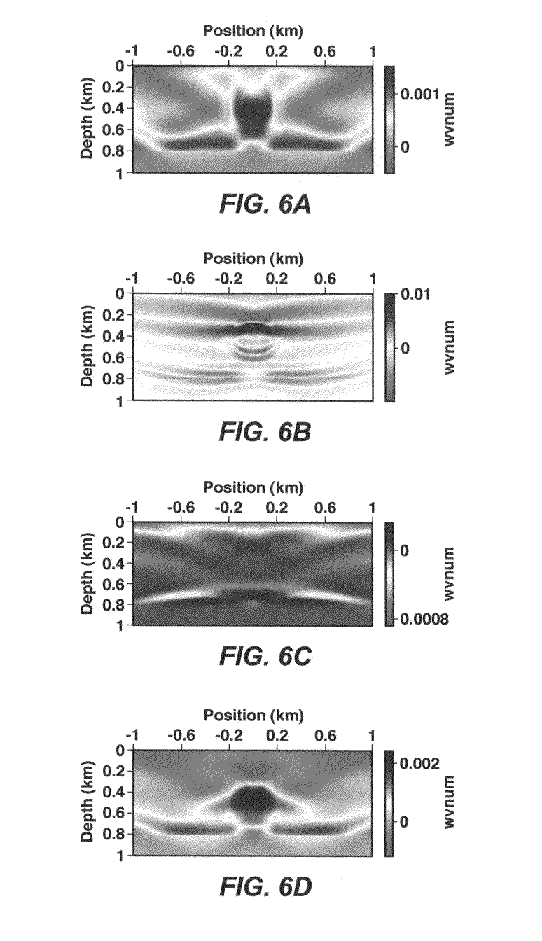

FIGS. 6A-6D show four different gradient components as described in section “Combining gradient components using the angle-domain Hessian”. FIGS. 6A-6D represent gradient components corresponding to g_{DD},g_{DU},g_{UD},g_{UU}, respectively.

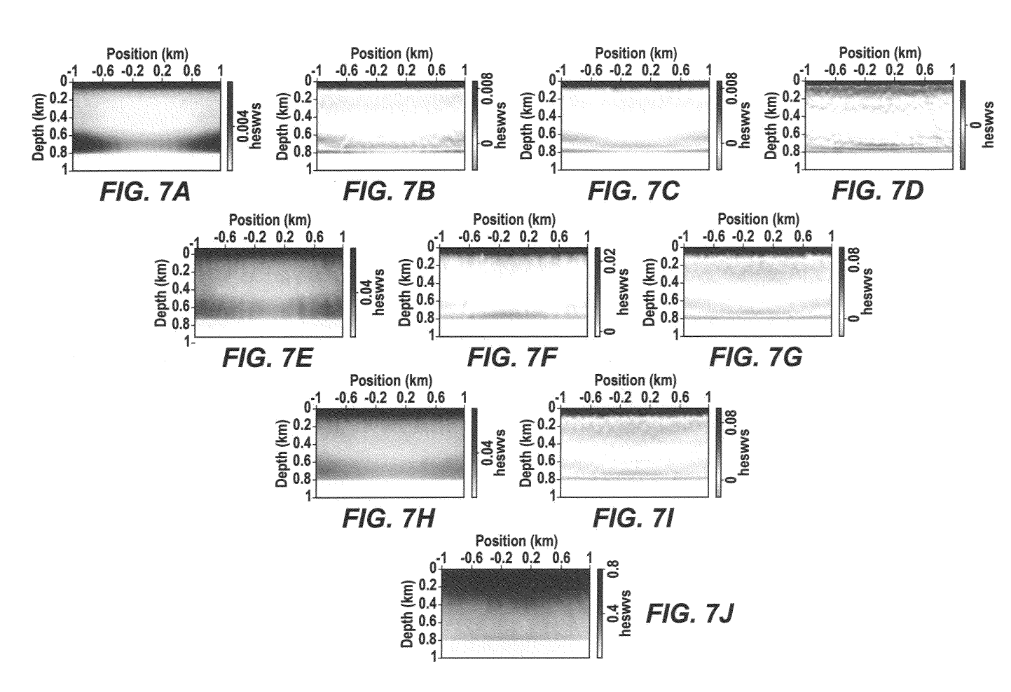

FIGS. 7A-7J show the corresponding decomposed Hessian components. FIGS. 7A-7J represent Hessian component corresponding to H_{DD}^{DD},H_{DU}^{DD},H_{UD}^{DD},H_{UU}^{DD},H_{DU}^{DU},H_{UD}^{DU},H_{UU}^{DU},H_{UD}^{UD},H_{UU}^{UD},H_{UU}^{UU}, respectively. FIGS. 7A-7J show only 10 components instead of 16, because the Hessian matrix is symmetric, hence computing only 10 is sufficient.

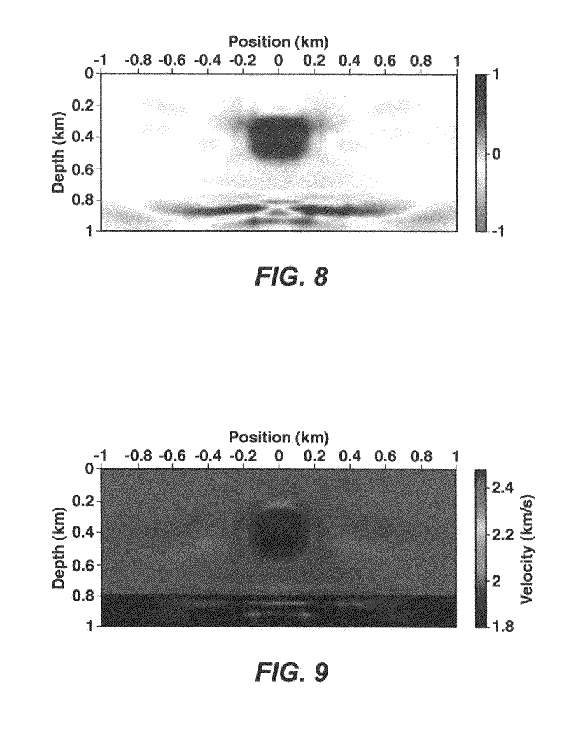

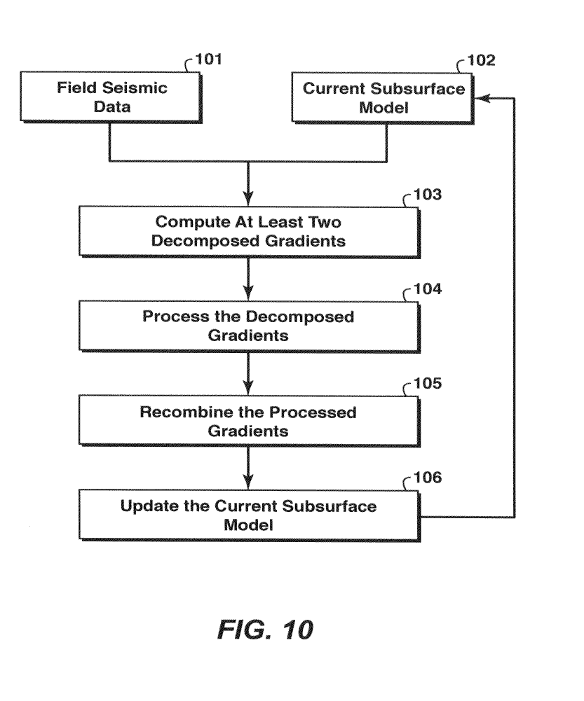

FIG. 8 shows the recombined gradient at the first iteration obtained by inverting the 4 by 4 angle-domain Hessian at each image point. Since different gradient component has been properly weighted according to the angle-domain Hessian, the new gradient provides both long and short wavelength updates.

FIG. 9 shows the inversion result after 10 iterations using the gradient obtained by inverting the angle-domain Hessian. The circular anomaly has been properly reconstructed, even better than in FIG. 5 where the single-direction update embodiment of the invention was used.

The foregoing application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims. Persons skilled in the art will readily recognize that in preferred embodiments of the invention, some or all of the steps in the present inventive method are performed using a computer, i.e. the invention is computer implemented. In such cases, the resulting gradient or updated physical properties model may be downloaded or saved to computer storage.

### REFERENCES

Bunks, C., F. M. Saleck, S. Zaleski, and G. Chavent, Multiscale seismic waveform inversion, Geophysics 60, 1457-1473 (1995).
Dickens, T. A., and G. A. Winbow, RTM angle gathers using Poynting vectors, SEG Technical Program Expanded Abstracts 30, 3109-3113 (2011).
Hu, L.-Z., and G. A. McMechan, Wave-field transformations of vertical seismic profiles, Geophysics 52, 307-321 (1987).
Lazaratos, S., I. Chikichev, and K. Wang, Improving the convergence rate of full wavefield inversion using spectral shaping, SEG Technical Program Expanded Abstracts 30, 2428-2432 (2011).
Liu, F., G. Zhang, S. A. Morton, and J. P. Leveille, Reverse-time migration using one-way wavefield imaging condition, SEG Technical Program Expanded Abstracts 26, 2170-2174 (2007).
Liu, F., G. Zhang, S. A. Morton, and J. P. Leveille, An effective imaging condition for reverse-time migration using wavefield decomposition, Geophysics 76, S29-S39 (2011).
Liu, W., Reverse time migration back-scattering noise removal using decomposed wavefield directivity, U.S. Patent Application No. US 2012/0051176 A1 (2012).
Mora, P., 1987, Elastic Wavefield Inversion, PhD thesis, Stanford University, pages 22-25 (1987).
Mora, P., Inversion=migration+tomography: Geophysics 54, 1575-1586 (1989).
Pratt, R. G., Seismic waveform inversion in the frequency domain, Part 1: Theory and verification in a physical scale model, Geophysics 64, 888-901 (1999).
Sheng, J., A. Leeds, M. Buddensiek, and G. T. Schuster, Early arrival waveform tomography on near-surface refraction data, Geophysics 71, U47-U57 (2006).
Tang, Y., Wave-equation Hessian by phase encoding, SEG Technical Program Expanded Abstracts 27, 2201-2205 (2008).
Tang, Y., Target-oriented wave-equation least-squares migration/inversion with phase-encoded Hessian, Geophysics 74, WCA95-107 (2009).
Tang, Y., and S. Lee, Preconditioning full waveform inversion with phase-encoded Hessian, SEG Technical Program Expanded Abstracts 29, 1034-1037 (2010).
Xie, X., and R. Wu, Extracting angle domain information from migrated wavefield, SEG Technical Program Expanded Abstracts 21, 1360-1363 (2002).
Xie, X.-B., S. Jin and R.-S. Wu, Wave-equation-based seismic illumination analysis, Geophysics 71, no. 5, S169-S177 (2006).
Yoon, K., K. J. Marfurt, and W. Starr, Challenges in reverse-time migration, SEG Technical Program Expanded Abstracts 23, 1057-1060 (2004).

1. A computer-implemented method for updating a physical properties model of a subsurface region in iterative inversion of seismic data using a gradient of a cost function that compares the seismic data to model-simulated data, said method comprising, in one or more iteration cycles:
decomposing the gradient into at least two components, using a computer;
weighting the components unequally;
recombining the weighted components to obtain a modified gradient; and
using the modified gradient to update the physical properties model.

2. The method of claim 1, wherein the seismic data are full wavefield data.

3. The method of claim 1, wherein the gradient is decomposed into two components, a migration component that updates predominately shorter wavelengths and a tomographic component that updates predominately longer wavelengths.

4. The method of claim 3, wherein if the seismic data are lacking in low temporal frequencies, the weighting enhances the tomographic component relative to the migration component.

5. The method of claim 3, wherein the weighting is determined according to whether the seismic data are reflection dominated or transmission dominated.

6. The method of claim 5, wherein if the seismic data are reflection dominated, the weighting enhances the tomographic component, and if the seismic data are transmission dominated, the weighting enhances the migration component.

7. The method of claim 3, wherein the weighting is determined by how closely the physical properties model, before the updating, is considered to be converged to a true solution, with the migration component being enhanced relative to the tomographic component if the physical properties model is close to the true solution, and the tomographic component is enhanced relative to the migration component if the physical properties model is far from the true solution.

8. The method of claim 3, wherein the migration component and the tomographic component are determined by decomposing source and receiver wavefields in the seismic data into an up-going direction and a down-going direction.

9. The method of claim 3, wherein the migration component and the tomographic component are determined by applying a band-pass filter to the gradient.

10. The method of claim 3, wherein the weights for the tomographic and the migration components are determined adaptively through the application of the Gauss-Newton Hessian operator.

11. The method of claim 1, wherein the gradient is decomposed into more than two components by decomposing wavefields represented in the seismic data into more than two components.

12. The method of claim 11, wherein the decomposing of the wavefields is performed by one of:
using frequency-wavenumber domain separation;
using time-wavenumber domain separation;
using a Poynting vector; and
by local slant stack.

13. The method of claim 11, wherein the weighting is spatially varying.

14. The method of claim 13, wherein the gradient is decomposed into four components by decomposing both source and receiver wavefields in the seismic data into up-going and down-going components and cross-correlating each decomposed component in the source wavefield with each decomposed component in the receiver wavefield.

15. The method of claim 14, wherein the four decomposed components of the gradient are recombined by inverting a 4 by 4 matrix at each subsurface point, wherein each element of the matrix represents one component of a decomposed angle-dependent Hessian operator.

16. The method of claim 15, wherein the decomposed Hessian is computed based on decomposing both source and receiver-side band-limited Green's functions into up-going and down-going directions and cross-correlating and convolving different combinations of the decomposed source and receiver-side Green's functions.

17. The method of claim 15, wherein the seismic data being inverted are a full wavefield, and the angle-dependent Hessian operator is computed by decomposing source and receiver-side band-limited Green's functions into angle-dependent band-limited Green's functions.

18. The method of claim 17, wherein dimensionality of the angle-dependent Hessian operator is reduced by neglecting a spatial blurring effect of said operator.

19. The method of claim 18, wherein the angle-dependent Hessian operator is used to convert an angle-dependent gradient into an angle-dependent update of the physical properties model.

20. A computer program product, comprising a non-transitory computer usable medium having a computer readable program code embodied therein, said computer readable program code adapted to be executed to implement a method for performing iterative inversion of full wavefield seismic data, using a gradient of a cost function that compares the seismic data to model-simulated data, to infer a physical properties model of a subsurface region, said method comprising in each iteration cycle:
decomposing the gradient into at least two components;
weighting the components unequally;
recombining the weighted components to obtain a modified gradient; and
using the modified gradient to update the physical properties model.
